(19) United States
(12) Patent Application Publication
(10) Pub. No.: US 2024/0067008 A1
(43) Pub. Date: Feb. 29, 2024

(54) CHARGING INLET

(71) Applicant: DESIGNWERK TECHNOLOGIES AG, CH-8408 WINTERTHUR (CH)

(72) Inventor: Frank LOACKER, Pfungen (CH)

(73) Assignee: DESIGNWERK TECHNOLOGIES AG, CH-8408 WINTERTHUR (CH)

(21) Appl. No.: 18/270,072

(22) PCT Filed: Jan. 5, 2022
(86) PCT No.: PCT/EP2022/050121

§ 371 Date: Jun. 28, 2023

(30) Foreign Application Priority Data
Jan. 11, 2021 (CH) 00016/21

(51) Int. Cl. B60L 53/16; B60L 53/18; B60L 53/302

(52) U.S. Cl. CPC B60L 53/16; B60L 53/18; B60L 53/302

(57) ABSTRACT

A charging inlet (1) for interconnecting an external power supply to a battery system of an electric vehicle to charge the battery system. The charging inlet (1) typically comprises a socket (2) suitable to receive during charging a compatible plug, wherein said socket (2) comprising at least one first inlet pole (3) and at least one second inlet pole (4) for connecting to the external power supply via the compatible plug. Usually a first conductor (5) is interconnected electrically and thermally to the first inlet pole (3) and a second conductor (6) is interconnected electrically and thermally to the second inlet pole (4). A cooling member (7) can be thermally interconnected to the first and the second conductor (5, 6) to provide a heat sink for the socket (2) and the plug during charging.

### BACKGROUND OF THE INVENTION

### Field of the Invention

The present disclosure is directed towards the field of charging inlets for electric vehicles.

### Discussion of Related Art

For charging the batteries of an electric vehicle, the batteries need to be connected to an external power supply. This can typically be done via a charging inlet, as known from the prior art.

DE 102017113920 A1 published in December 2018 in the name of IAV GmbH

Ingenieurgesellschaft Auto and Verkehr, relates a charging port cooler for mechanically contacted charging ports, which have incoming lines of a first cross-section coming from a charging socket and leading to the charging port cooler and are accommodated in a housing of the charging port cooler. These are electrically contacted directly or indirectly via contacts with outgoing lines from the charging port cooler, the outgoing lines being led out of the housing of the charging connection cooler. The outgoing lines have a second cross-section which is smaller than the first cross-section of the incoming lines. Furthermore, the contacts of the outgoing and incoming lines are surrounded by an electrically insulating and at the same time good heat-conducting material and the housing is designed to enclose this material.

U.S. Ser. No. 10/377,264 B2 published in August 2019 in the name of Ford Global Tech LLC, relates to a vehicle conductive charge port. The charging port is configured to conductively transfer charging current from an external source to the vehicle for charging a traction battery of the vehicle. A cooling system is configured to cool the charge port depending on a temperature of the charge port. The cooling system uses a coolant or air to cool the charge port.

### SUMMARY OF THE INVENTION

Charging inlets for connecting an external power supply to a battery system of an electric vehicle as known from the prior art face several problems when aiming for ever shorter charging times and thus higher charging power and in turn higher charging currents. On the side of the external power supply more often cooled cables are used, however this is no longer sufficient for cooling the mechanical contacts conducting the necessary currents between the vehicle and the power supply.

A first aspect of the disclosure is thus directed towards a charging inlet for interconnecting an external power supply to a battery system of an electric vehicle to charge the battery system. The charging inlet usually comprises a socket suitable to receive during charging a compatible plug. The plug is normally interconnected to the external power supply via a cable. The socket typically comprises at least one first inlet pole and at least one second inlet pole for connecting to the external power supply via the compatible plug; however, additional inlet poles are possible. Particularly when transmitting high currents, via mechanical contacts between the inlet poles and the poles of the plug, heat may be generated. In order to allow for consistently high charging currents, the heat should be dissipated in an efficient manner. The charging inlet according to the disclosure typically comprises at least one first conductor interconnected electrically and thermally to the first inlet pole and at least one second conductor interconnected electrically and thermally to the second inlet pole. During charging the first and the second inlet poles are usually electrically and thermally interconnected to associated poles of the plug for a limited time period.

Preferably a cooling member is thermally interconnected to the first and the second conductor to provide a heat sink for the socket and the plug during charging. This allows to not only dissipate the heat generated at the inlet poles, but in addition can provide cooling during charging to the poles of the plug received in the socket. In case the socket comprises more than two inlet poles, these may be thermally interconnected to the cooling member as well. The socket is preferably formed compliant with norms for the conductive charging of electrical vehicles, such as the international norm IEC 62196. The socket is in some variations of the charging inlet implemented as a “Combined Charging System” (CCS) type 2 socket.

The herein described charging inlet is suitable all types of electric vehicles, however it is particularly suitable for electric trucks. Electric trucks, in particular electric trucks comprising two or more battery packs, usually have a lager battery capacity than for example passenger cars and therefore require especially high currents during charging in order to achieve a short charging time.

Depending on the field of application the first and the second conductor are respectively interconnected to the battery system by a first and a second cable connection preferably having a cross-section area which is larger than the cross-section area of the respective first and second conductor. A larger cross-section area typically reduces the resistance of a conductor and therefore the heat generated when conducting currents, in particular high currents. As a result, the cooling performance required is reduced by a larger cross-section area of the first and the second cable connection.

For optimized electrical coupling and decoupling the socket from the battery system, each cable connection is interconnected to the respective conductor respectively by a relay, in particular a first and a second relay. The first and second relays can couple or decouple the respective conductor from the respective cable connection. Usually, the socket is decoupled from the battery system when no charging of the battery system is in progress. This increases the safety of the inlet as the inlet poles can be essentially voltage-free when no plug is connected to the socket.

To achieve good protection from environmental influences, the socket, the cooling member and the first and second conductors are preferably arranged in a housing. The housing can be essentially box-shaped; however other shapes are possible. For added heat dissipation the housing may be at least partially made from a thermally conductive material, such as metal, however other materials are thinkable. The housing is preferably arranged onboard the electric vehicle. The socket may be accessible from outside the vehicle via an access passage in the housing at least temporarily.

At least one of the relays is cooled, in particular the first and the second relay are cooled respectively. In a variation the relays are thermally interconnected to the housing. Alternatively, or in addition at least one of the relays is preferably interconnected to the cooling member in a thermally conductive manner.

Depending on the field of application, at least one of the cable connections is interconnected to the respective relay by sheet metal. The sheet metal has preferably a cross-section area which, is larger than the cross-section area of the respective first and second conductor. In particular, busbars can be interconnecting the cable connections to the respective relay. The first and the second conductor can be formed as a round cable or a conductive sheet metal, however other conductor shapes are thinkable.

For an easy installation of the charging inlet, each cable connection is preferably interconnected to the respective relay by at least one connector, in particular at least one connector connects the respective cable connection to the respective sheet metal. If appropriate the connectors are formed as quick connectors, e.g., as bayonet type connectors or latch type connectors. Preferably two connectors are interconnected to the respective relay, in particular via the respective sheet metals. Depending on the construction each cable connection can comprise at least two essentially parallel cables. The cables may be connected to the connectors and therewith electrically to the relays, in particular via the respective sheet metal.

Although being thermally interconnected, the cooling member is preferably electrically isolated from the first and the second conductor. This is possible when the first and second conductor are at least partially encased by an insulating material, such as a plastic sheath. In a preferred variation this is achieved, when at least one of the conductors is thermally interconnected to the cooling member by a thermally conductive paste-like material, in particular a thermally conductive and electrically insulating material. This ensures a good transfer of heat from the at least one conductor to the thermal member as an essentially (air)gapless thermal interconnection is possible.

In order to provide efficient cooling the cooling member preferably comprises at least one cooling channel. Alternatively, or in addition, the thermal member may comprise at least one cooling fin for passive heat dissipation. Depending on the design, the thermal member can be formed as separate part or can be incorporated into the housing. If appropriate the thermal member is attached to the inside of the housing. In some variations the cooling channel forms a closed loop within the thermal member; however, in a preferred variation the cooling channel is interconnected to a cooling circuit, e.g., via cooling channel connectors. The cooling channel may comprise at least one meandering turn, in particular two, or three turns. The at least one meandering turn is preferably arranged next to the first and/or second conductor.

In some variations the thermal member comprises a body, in particular at least partially made from a thermally conductive material. The body may comprise a groove and a cover, wherein the cover is attached to the body overlapping the groove, such that they together form at least partially the cooling channel. Alternatively, or in addition, the cooling channel can be at least partially formed by a pipe at least partially accommodated in a groove of the body. Depending on the implementation the body may comprise at least one recess for accommodating at least one of the relays in a thermally interconnected manner. Alternatively, or in addition, the body may comprise at least one indentation for accommodating the first and/or the second conductor.

In order to monitor the charging inlet, in particular the temperature, at least one thermal sensor may be thermally interconnected to at least one of the conductors. The thermal sensor is preferably arranged with respect to one of the relays connected to the first or the second conductor. Good results are possible when a control unit is interconnected to at least one of the relays for controlling and or monitoring the relays. In particular, the control unit configures to switch the relays, such that the socket is decoupled from battery system when no charring is in progress. Depending on the design, the control unit is configured to communicate with a vehicle control unit or a battery management unit, in particular via a CAN-Bus (Controller Area Network) connection. For increased safety, the control unit can be configured to decouple the battery system from the socket, by switching at least one of the relays. Preferably is the control unit configured to receive thermal data from the at least one thermal sensor and to switch at least one of the relays, when a breach of a definable threshold for the temperature based on the received temperature data is detected.

To protect the socket and in particular the inlet poles against environmental conditions, the housing may comprise a socket cover arranged between the socket and the outside of the housing slidably against the force of a spring, such that the socket is covered when no plug is received in the socket. The socket cover can be slid from a covering position to an open position to give access to the socket. The socket cover can be formed as a metal plate or the like. The control unit, as described before, is preferably arranged inside the housing; however, the control unit can be incorporated into a vehicle control unit or a battery management unit.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The herein described disclosure will be more fully understood from the detailed description given herein below and the accompanying drawings which should not be considered limiting to the disclosure described in the appended claims. The drawings are showing:

FIG. 1 shows a first variation of a charging inlet according to the disclosure;

FIG. 2 shows the first variation of the charging inlet of FIG. 1 in a partially disassembled and exploded view from a downward perspective; and

FIG. 3 shows the first variation of the charging inlet of FIG. 1 in a partially disassembled and exploded view from an upward perspective.

### DETAILED DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

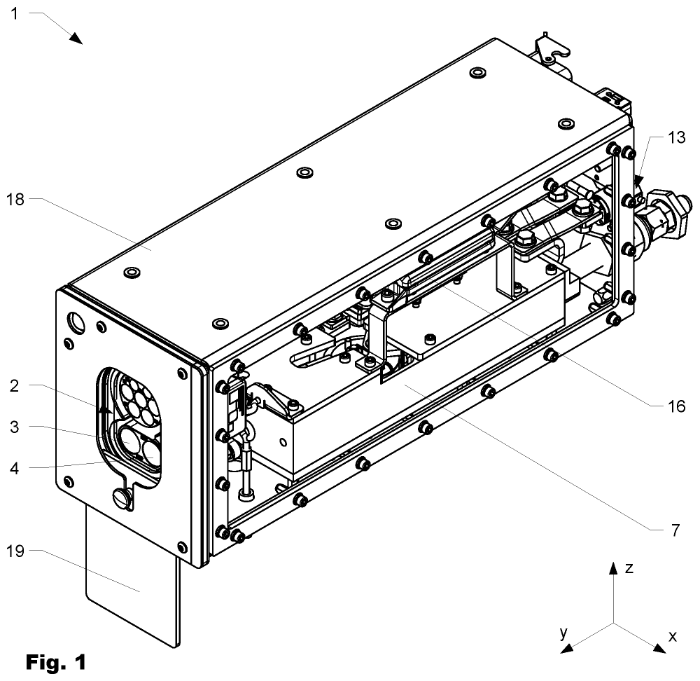

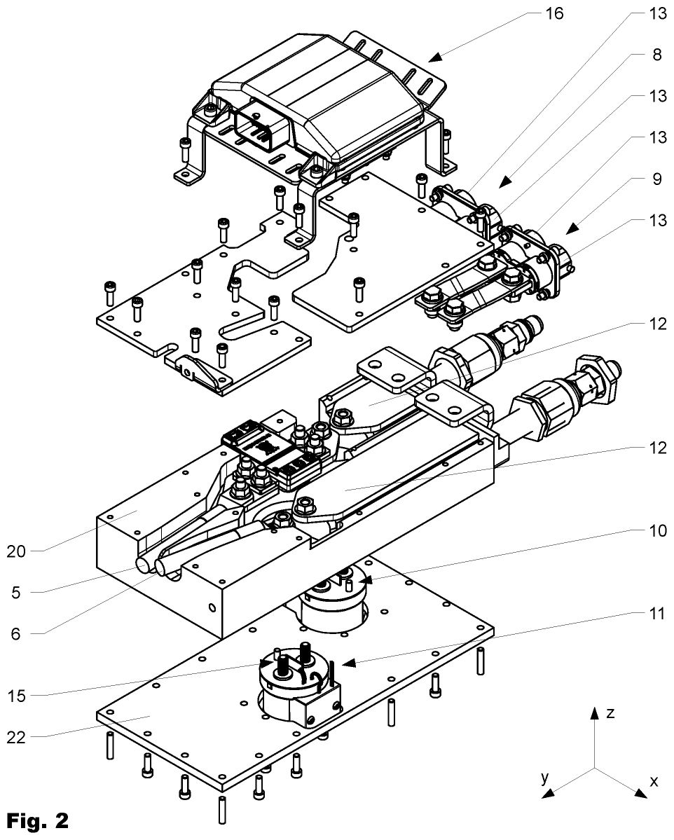

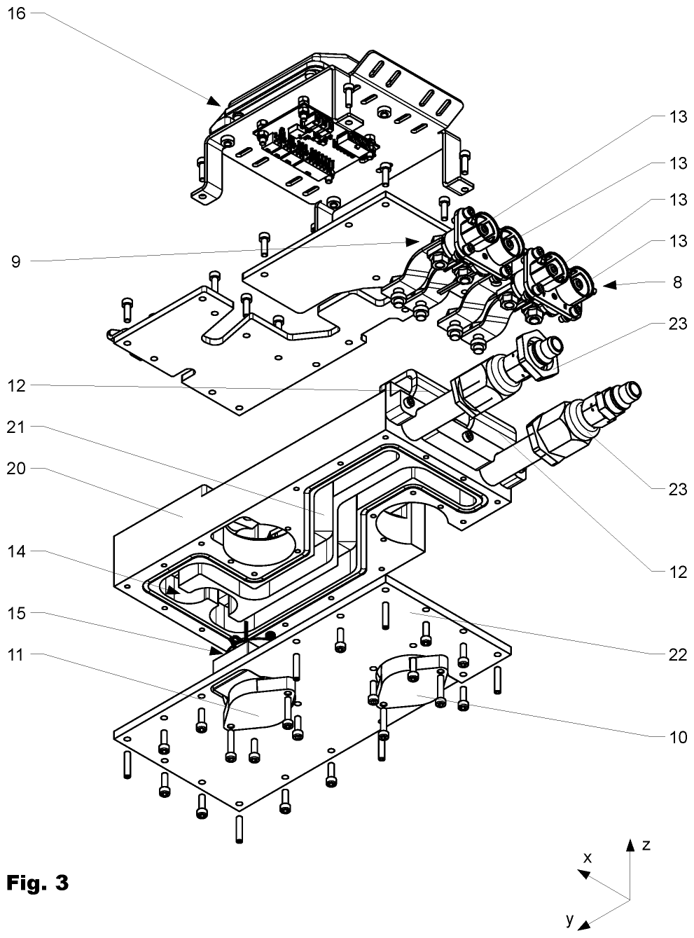

FIG. 1 shows a first variation of a charging inlet 1. FIGS. 2 and 3 show the first variation of FIG. 1 in a partially disassembled and exploded view from two different perspectives.

A charging inlet 1, as shown in a first variation in FIG. 1, can be used for interconnecting an external power supply to a battery system of an electric vehicle to charge the battery system. The charging inlet 1 usually comprises a socket 2 suitable to receive during charging a compatible plug (not shown). The socket 2 of the first variation comprises at least one first inlet pole 3 and at least one second inlet pole 4 for connecting to the external power supply via the plug. The charging inlet 1 typically comprises, as best visible in FIG. 2, at least one first conductor 5 interconnected electrically and thermally to the first inlet pole 3 and at least one second conductor 6 interconnected electrically and thermally to the second inlet pole 4. This way heat can be transported away from the inlet poles 3, 4 and the thereto, at least during charging, inter-connected plug by means of the first and the second conductor 5, 6.

To achieve a good cooling, a cooling member 7 is thermally interconnected to the first and the second conductor 5, 6 to provide a heat sink for the socket 2 and the plug during charging. The cooling member 7 of the shown variation comprises at least one cooling channel 14, to allow active and therefore efficient cooling. As best visible in FIG. 3, the cooling channel 14 is typically interconnected to a cooling circuit (not shown), in particular via cooling channel connectors 23. The cooling channel connectors 23 are in particular of a quick coupling type.

The cooling member 7, as shown in FIGS. 2 and 3 may comprise a body 20 with indentations for accommodating the first and/or the second conductor 5, 6. The indentations are preferably shaped essentially as the first and/or the second conductor 5, 6. The body 20 may comprise a groove 21 and a cover 22, wherein the cover 22 is attached to the body 20 overlapping the groove 21, such that they together form at least partially the cooling channel 14. The cooling channel 14 comprises at least one meandering turn for increased heat dissipation. The at least one meandering turn is in the first variation arranged next to the first and second conductor 5, 6. In the shown variation the cooling channel 14 comprises three meandering turns next to the first and the second conductor 5, 6.

As best visible in FIG. 2, the first and the second conductor 5, 6 are respectively interconnected to the battery system (not shown) by a first and a second cable connection 8, 9 each having a cross-section area which is larger than the cross-section area of the respective first and second conductor 5, 6. This allows to omit an active cooling of the first and the second cable connection 8, 9, as their surface area is sufficient to dissipate the heat generated during charging. The respective cross-section area of the first and the second cable connection 8, 9 can, in particular, be around twice the cross-section area of the respective first and second conductor 5, 6.

Interposed between the first conductor 5 and the first cable connection 8 is in the shown variation a first relay 10. As shown in FIG. 2, a second relay 11 is interposed between the second conductor 6 and the second cable connection 9. At least one of the cable connections 8, 9 is interconnected to the respective relay 10, 11 by a sheet metal 12. As visible in FIG. 2 each of the cable connections 8, 9 interconnected to the respective relay 10, 11 by a sheet metal 12, in particular a busbar. The sheet metals 12 are each thermally interconnected to the cooling member 7. Each cable connection 8, 9 can be interconnected to the respective relay 10, 11 by at least one connector 13, in particular at least one quick connector 13 connects the respective cable connection 8, 9 to the respective sheet metal 12. In the variation shown, two connectors 13 are inter-connected to the respective sheet metal 12. Each cable connection 8, 9 can comprise two essentially parallel cables (not shown) connectable to the respective two connectors 13 of the cable connection 8, 9.

Depending on the implementation the body 20 comprises at least one recess for accommodating at least one of the relays 10, 11 in a thermally interconnected manner. Visible in FIG. 3 are two essentially cylindrical recesses of the body 20 to accommodate the first and the second relay 10, 11. Preferably the cooling member 7 is electrically isolated from the first and the second conductor 5, 6. In the first variation shown, the conductors 5, 6 are thermally inter-connected to the cooling member 7 by a thermally conductive paste-like material, in particular a thermally conductive and electrically insulating material. For good thermal interconnection, the body 20 preferably comprises at least one groove-like indentation for accommodating at least one of the first and the second conductor 5, 6 therein. Typically, the body 20 comprises a groove-like indentation per conductor 5, 6.

The socket 2, the cooling member 7 and the conductors 5, 6 are preferably arranged in a housing 18, as shown in FIG. 1. The housing 18 of the first variation is essentially box-shaped and is at least partially made from metal to allow additional heat dissipation via the outside surfaces.

As indicated in FIG. 2, at least one thermal sensor 15 is usually thermally interconnected to at least one of the conductors 5, 6. In the first variation the at least one thermal sensor 15 is incorporated into the first and/or second relay 10, 11. A control unit 16 is usually interconnected to at least one of the relays 10, 11 for controlling and or monitoring the relays. As shown in FIG. 1, the control unit 16 is preferably arranged in the housing 5. The control unit 16 is in the first variation interconnected to a vehicle control unit (not shown) via a CAN-Bus connection.

Rather, the words used in the specification are words of description rather than limitation, and it is understood that various changes may be made without departing from the scope of the disclosure.

1. A charging inlet (1) for interconnecting an external power supply to a battery system of an electric vehicle to charge the battery system, the charging inlet (1) comprising:
a. a socket (2) suitable to receive during charging a compatible plug, the socket (2) comprising at least one first inlet pole (3) and at least one second inlet pole (4) for connecting to the external power supply via the compatible plug;
b. a first conductor (5) interconnected electrically and thermally to the first inlet pole (3) and a second conductor (6) interconnected electrically and thermally to the second inlet pole (4);
c. a cooling member (7) thermally interconnected to the first and the second conductor (5, 6) to provide a heat sink for the socket (2) and the plug during charging.

2. The charging inlet (1) according to claim 1, wherein the first and the second conductor (5, 6) are respectively interconnected to the battery system by a first and a second cable connection (8, 9) having a cross-section area which is larger than the cross-section area of the respective first and second conductor.

3. The charging inlet (1) according to claim 2, wherein each cable connection (8, 9) is interconnected to the respective conductor (5, 6) respectively by a first or a second relay (10, 11).

4. The charging inlet (1) according to claim 3, wherein at least one of the relays (10, 11) is cooled.

5. The charging inlet (1) according to claim 3, wherein at least one of the relays (10, 11) is thermally interconnected to the cooling member (7).

6. The charging inlet (1) according to claim 2, wherein at least one of the cable connections (8, 9) is interconnected to the respective relay (10, 11) by a sheet metal (12).

7. The charging inlet (1) according to claim 6, wherein each cable connection (8, 9) is interconnected to the respective relay (10, 11) by at least one quick connector (13) connecting the respective cable connection (8, 9) to the respective sheet metal (12).

8. The charging inlet (1) according to claim 1, wherein the cooling member (7) is electrically isolated from the first and the second conductor (5, 6).

9. The charging inlet (1) according to claim 1, wherein the cooling member (7) comprises at least one cooling channel (13).

10. The charging inlet (1) according to claim 1, wherein at least one thermal sensor (15) is thermally interconnected to at least one of the conductors (5, 6), such that the thermal sensor (15) is arranged with respect to one of the relays (10, 11).

11. The charging inlet (1) according to claim 1, wherein a control unit (16) is interconnected to at least one of the relays (10, 11) for controlling and or monitoring the relays (10, 11).

12. The charging inlet (1) according to claim 2, wherein each cable connection (8, 9) comprises at least two essentially parallel cables.

13. The charging inlet (1) according to claim 1, wherein at least one of the conductors (5, 6) is thermally interconnected to the cooling member (7) by a paste-like a thermally conductive and electrically insulating material.

14. The charging inlet (1) according to claim 1, wherein the socket (2), the cooling member (7) and conductors (5, 6) are arranged in a housing (18).

15. The charging inlet (1) according to claim 14, wherein the housing (18) comprises a socket cover (19) arranged between the socket (2) and the outside of the housing (18) slidably against the force of a spring, such that the socket (2) is covered when no plug is received in the socket (2).
